(19) United States
(12) Patent Application Publication
(10) Pub. No.: US 2014/0349770 A1
(43) Pub. Date: Nov. 27, 2014

(54) INFORMATION PROCESSING DEVICE, AND NON-TRANSITORY COMPUTER-READABLE STORAGE MEDIUM STORING GAME PROGRAM

(71) Applicant: DENA CO., LTD., TOKYO (JP)

(72) Inventors: Masaki ARIZUKA, Tokyo (JP); Yusuke SUMAKI, Tokyo (JP); Taku TOMONARI, Tokyo (JP); Takashi OHKUBO, Tokyo (JP); Hiroshi KOYAMA, Tokyo (JP); Masanori KAGA, Tokyo (JP); Takao MUKAI, Tokyo (JP)

(73) Assignee: DENA CO., LTD., TOKYO (JP)

(21) Appl. No.: 14/067,551

(22) Filed: Oct. 30, 2013

(30) Foreign Application Priority Data
May 24, 2013 (JP) 2013-110226

(51) Int. Cl. A63F 13/00

(52) U.S. Cl. CPC A63F 13/00
USPC 463/43

(57) ABSTRACT

An information processing device according to the present invention includes: a storage unit configured to store possessed character information that is information related to characters possessed by a player and a game parameter indicating an accumulation state of points possessed by the player in association with the player; a character selection unit configured to select a main character and a sub character from among the characters possessed by the player; a point accumulation unit configured to accumulate points by updating the possessed character information so that the sub character selected by the character selection unit is made into a character not possessed by the player and by adding the number of points corresponding to the sub character to the game parameter; and a parameter varying unit configured to vary a parameter set to the main character by causing the points accumulated by the point accumulation unit to be consumed.

### CROSS-REFERENCE TO RELATED APPLICATION(S)

This application claims the benefit of Japanese Patent Application No. 2013-110226, filed May 24, 2013, the disclosure of which is hereby incorporated by reference in its entirety.

### BACKGROUND OF THE INVENTION

1. Field of the Invention

The present invention relates to an information processing device and a game program.

2. Description of Related Art

Game systems in which a player plays a game using game contents such as a character have been known (for example, Japanese Patent Application Laid-Open No. 2008-264183).

### SUMMARY OF THE INVENTION

In such a game system, a character used in the game is provided to the player. While the player can possess the provided character, the number of characters that can be possessed by the player is limited. Therefore, the player has to give up the possession of characters.

The present invention has been made in view of the foregoing, and an objective is to bring the player a feeling as if he/she maintains possession of a character even if the player has given up the possession of the character, and to reinforce efficient use of the character, the possession of which has been given up.

A principal invention of the present invention to solve the above-described problems is

an information processing device including:

a storage unit configured to store possessed character information that is information related to characters possessed by a player and a game parameter indicating an accumulation state of points possessed by the player in association with the player;

a character selection unit configured to select a main character and a sub character from among the characters possessed by the player;

a point accumulation unit configured to accumulate points by updating the possessed character information so that the sub character selected by the character selection unit is made into a character not possessed by the player and by adding the number of points corresponding to the sub character to the game parameter; and

a parameter varying unit configured to vary a parameter set to the main character by causing the points accumulated by the point accumulation unit to be consumed.

Other characteristics of the present invention will become clear from the description of the present specification and the appended drawings.

According to the present invention, the player is caused to have a feeling as if he/she maintains possession of a character even if the player has given up the possession of the character, and efficient use of the character, the possession of which has been given up, can be reinforced.

### BRIEF DESCRIPTION OF THE DRAWINGS

FIG. 1 is a diagram illustrating an overall configuration example of a game system;

FIG. 2 is a block diagram illustrating a functional configuration of a server device;

FIG. 3 is a block diagram illustrating a functional configuration of a player terminal;

FIG. 4 is a diagram illustrating an example of a data structure of character information;

FIG. 5 is a diagram illustrating an example of a data structure of player information;

FIG. 6 is a diagram illustrating an example of a data structure of possessed character information;

FIG. 7 is a diagram illustrating an example of a data structure of picture book information;

FIG. 8 is a diagram illustrating an example of a data structure of item information;

FIG. 9 is a flowchart for describing an operation example related to setting of a base character;

FIG. 10 is a diagram illustrating an example of a game screen for base character setting;

FIG. 11 is a diagram illustrating an example of a game screen for designating a base character by the player;

FIG. 12 is a diagram illustrating an example of a game screen for automatically designating a base character;

FIG. 13 is a flowchart for describing an example of an operation of accumulating points by performing manual point conversion;

FIG. 14 is a diagram illustrating an example of a game screen for material character designation;

FIG. 15 is a diagram illustrating a game screen for individual selection;

FIG. 16 is a diagram illustrating an example of a game screen for collective selection;

FIG. 17 is a diagram illustrating an example of a game screen for point accumulation;

FIG. 18 is a flowchart for describing an example of an operation of accumulating points by performing automatic point conversion;

FIG. 19 is a diagram illustrating an example of a game screen for character providing;

FIG. 20 is a flowchart for describing an example of an operation related to reinforcement of a base character;

FIG. 21 is a diagram illustrating an example of a game screen for base character reinforcement; and

FIG. 22 is a diagram illustrating an example of a game screen indicating a base character after reinforcement.

### DETAILED DESCRIPTION OF THE INVENTION

At least the following matters will become clear according to the description of the present specification and the appended drawings.

That is, it is an information processing device that includes:

a storage unit configured to store possessed character information that is information related to characters possessed by a player and a game parameter indicating an accumulation state of points possessed by the player in association with the player;

a character selection unit configured to select a main character and a sub character from among the characters possessed by the player;

a point accumulation unit configured to accumulate points by updating the possessed character information so that the sub character selected by the character selection unit is made into a character not possessed by the player and by adding the number of points corresponding to the sub character to the game parameter; and

a parameter varying unit configured to vary a parameter set to the main character by causing the points accumulated by the point accumulation unit to be consumed.

According to such an information processing device, the sub character, possession of which has been given up, is converted into points in advance, and a parameter of the main character can be varied using the accumulated points. Therefore, the player is caused to have a feeling as if he/she maintains the possession of the character even if he/she has given up the possession of the character, and efficient use of the character, the possession of which has been given up, can be reinforced.

Further, a providing unit configured to provide the player with a character; and

a determination unit configured to determine whether the character provided by the providing unit satisfies a predetermined condition, may be provided, and

the character selection unit may automatically select the character provided by the providing unit as the sub character when the determination is denied by the determination unit, and

the point accumulation unit may automatically add the number of points corresponding to the sub character to the game parameter.

According to such an information processing device, selection of the sub character, conversion to the points, and accumulation of the converted points are automatically performed. Therefore, work required for an operation input can be reduced.

Further, a providing unit configured to provide the player with a character selected by performing any of a plurality of types of lottery games; and

a determination unit configured to determine whether a lottery game that satisfies a predetermined condition among the plurality of types of lottery games has been performed, may be provided, and

the character selection unit may automatically select the character provided by the lottery game that satisfies the predetermined condition as the sub character when the determination is affirmed by the determination unit, and

the point accumulation unit may automatically add the number of points corresponding to the sub character to the game parameter.

According to such an information processing device, selection of the sub character, conversion into the points, and accumulation of the converted points are automatically performed according to the type of the lottery game. Therefore, the work required for an operation input can be reduced.

Further, the character selection unit may collectively select the sub characters to which a parameter that satisfies a predetermined condition is set from among the characters possessed by the player in response to an operation input from the player.

According to such an information processing device, the collective selection of the sub characters is automatically performed. Therefore, the work required for an operation input can be reduced.

Further, the point accumulation unit may add a larger number of points to the game parameter when the sub character selected by the character selection unit has a predetermined relationship with the main character than when the sub character does not have the predetermined relationship with the main character.

According to such an information processing device, the number of points according to the relationship between the main character and the sub character can be accumulated.

Next, it is a non-transitory computer-readable storage medium storing a game program for causing a computer to execute the processing of:

storing, in a storage unit, possessed character information that is information related to characters possessed by a player and a game parameter indicating an accumulation state of points possessed by the player in association with the player;

selecting a main character and a sub character from among the characters possessed by the player;

accumulating points by updating the possessed character information so that the sub character selected by the character selection unit is made into a character not possessed by the player and by adding the number of points corresponding to the sub character to the game parameter; and

varying a parameter set to the main character by causing the points accumulated by the point accumulation unit to be consumed.

According to such a game program, efficient use of a character, possession of which has been given up, can be reinforced.

### Embodiments

### <<Configuration of Game System 1>>

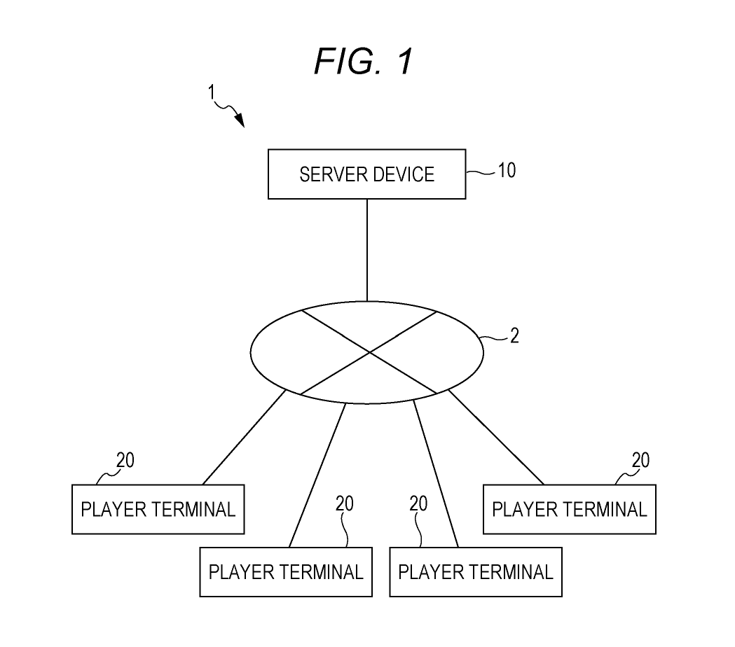

FIG. 1 is a diagram illustrating an example of an overall configuration of a game system 1 according to the present embodiment. The game system 1 provides a player with various services related to a game through a network 2 (for example, the Internet and the like), and includes a server device 10 and a plurality of player terminals 20.

### <<Configuration of Server Device 10>>

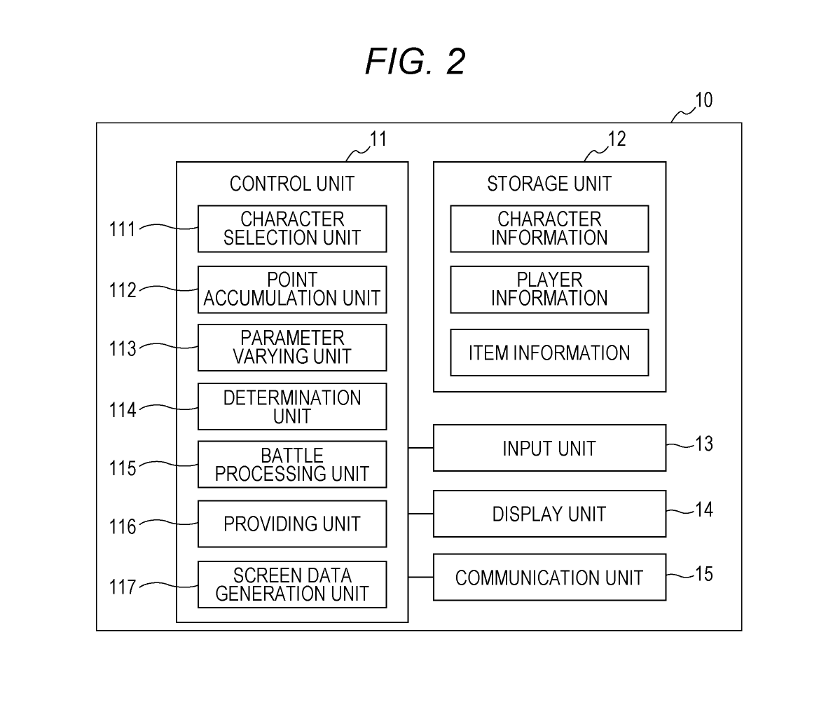

FIG. 2 is a block diagram illustrating a functional configuration of the server device 10 according to the present embodiment. The server device 10 is an information processing device (for example, a workstation, a personal computer, and the like) used when a system administrator and the like manage the game service. The server device 10 can distribute a game program operable on the player terminal 20, and a web page (game screen, and the like) made in a markup language (HTML, and the like) according to a specification of the player terminal 20 upon receiving various commands (requests) from the player terminal 20. The server device 10 includes a control unit 11, a storage unit 12, an input unit 13, a display unit 14, and a communication unit 15.

The control unit 11 performs data passing among units as well as controlling the entire server device 10, and is realized by a central processing unit (CPU) executing a program stored in a predetermined memory. The control unit 11 of the present embodiment includes a character selection unit 111, a point accumulation unit 112, a parameter varying unit 113, a determination unit 114, a battle processing unit 115, a providing unit 116, and a screen data generation unit 117.

The character selection unit 111 includes a function to execute a process of selecting any from a plurality of characters. The character selection unit 111 in the present embodiment selects a main character and a sub character from among a plurality of characters possessed by the player.

The point accumulation unit 112 includes a function to execute a process of accumulating points of a game parameter. The point accumulation unit 112 in the present embodiment accumulates the points by updating possessed character information so that the sub character selected by the character selection unit 111 is made into a character not possessed by the player, and by adding the number of points corresponding to the sub character to the game parameter.

The parameter varying unit 113 includes a function to execute a process of varying a parameter set to a character. The parameter varying unit 113 in the present embodiment varies the parameter set to the main character by causing the points accumulated by the point accumulation unit 112 to be consumed.

The determination unit 114 includes a function to execute various determination processes. The determination unit 114 in the present embodiment determines, for example, whether a character provided by the providing unit 116 satisfies a predetermined condition. The character that satisfies a predetermined condition is, for example, a character equipped with/possessing a special item, a character to which a high ability parameter or a high level is set, a character having a particular attribute, and the like. Further, the determination unit 114 in the present embodiment determines, for example, whether a lottery game that satisfies a predetermined condition among a plurality of types of lottery games has been performed when any of the plurality of types of lottery games is performed by the providing unit. The lottery game that satisfies a predetermined condition is, for example, a lottery game performed by causing virtual currency to be consumed, a lottery game in which a plurality of characters are provided in one lottery, and the like.

The battle processing unit 115 includes a function to execute a process of determining an outcome of a battle between a player character and a character that is an opponent. The battle processing unit 115 in the present embodiment includes a function to execute an attack process of decreasing a value of a physical parameter of the opponent character when the player character attacks the opponent character, for example.

The providing unit 116 includes a function to execute a process of providing the player with a character to be used in a game. The character means game contents as digital data, and examples of the character include a game character, a game card and a figure corresponding to a game character and the like, and items such as a tool and an ability that can be used in the game.

The screen data generation unit 117 includes a function to execute a process of generating screen data for displaying, in the player terminal 20, a game screen for allowing the player to play a game. The screen data generation unit 117 of the present embodiment generates HTML data as the screen data corresponding to the game screen.

The storage unit 12 includes a read only memory (ROM) that is a read only storage area in which a system program is stored, and a random access memory (RAM) that is a rewritable storage area used as a work area for arithmetic processing by the control unit 11. The storage unit 12 is, for example, realized by a non-volatile storage device, such as a flash memory or a hard disk. The storage unit 12 of the present embodiment stores at least character information that is information related to characters, player information that is information related to the player, and item information that is information related to items. Note that each of the information will be described in detail.

The input unit 13 is used by the system administrator and the like for inputting various data (for example, the character information and the like), and is realized by, for example, a keyboard, a mouse, and the like.

The display unit 14 is used for displaying an operation screen for the system administrator based on a command from the control unit 11, and is, for example, realized by a liquid crystal display (LCD) and the like.

The communication unit 15 is used for performing communication with the player terminal 20, and has a function as a reception unit that receives various data and signals transmitted from the player terminal 20, and a function as a transmission unit that transmits various data and signals to the player terminal 20 according to a command of the control unit 11. The communication unit 15 is, for example, realized by a network interface card (NIC), and the like.

### <<Configuration of Player Terminal 20>>

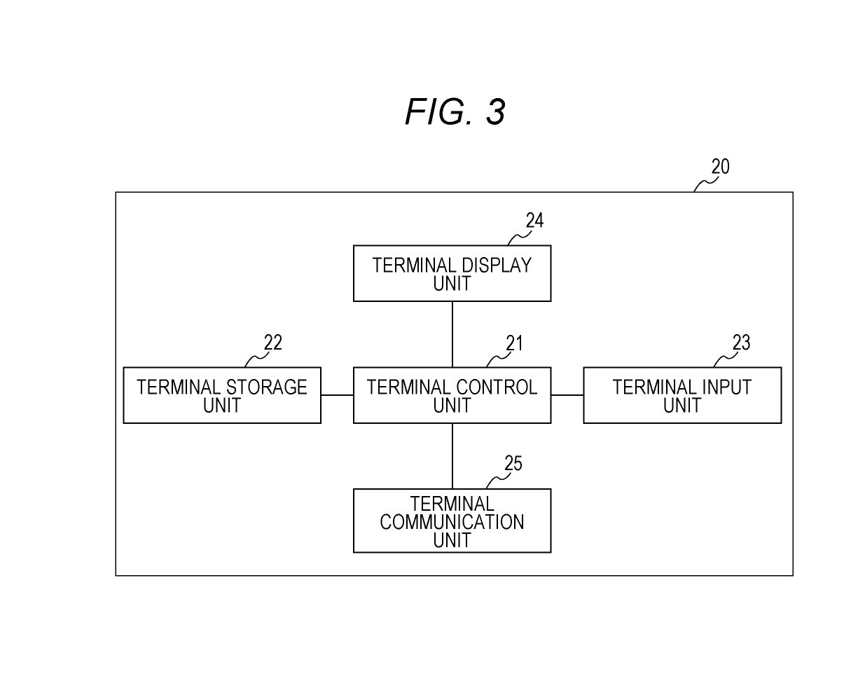

FIG. 3 is a block diagram illustrating a functional configuration of the player terminal 20. The player terminal 20 of the present embodiment is an information processing device (for example, a mobile phone terminal, a smart phone, and the like) used by the player when playing a game, and can request distribution of various types of information (a game program, a web page, and the like) related to the game to the server device 10. Since the player terminal 20 has a web browser function for allowing the player to browse a web page, the web page (a game screen, and the like) distributed from the server device 10 can be displayed on a screen. The player terminal 20 includes a terminal control unit 21, a terminal storage unit 22, a terminal input unit 23, a terminal display unit 24, and a terminal communication unit 25.

The terminal control unit 21 performs data passing among units and controls the entire player terminal 20, and is realized by the central processing unit (CPU) executing a program stored in a predetermined memory. Note that the terminal control unit 21 of the present embodiment also functions as a screen display control unit that controls a display form of the game screen displayed in the terminal display unit 24. The terminal storage unit 22 is connected to the terminal control unit 21 through a bus, and performs processing of referring to, reading out, rewriting stored data according to a command from the terminal control unit 21. The terminal storage unit 22 is realized, for example, by a flash memory, a hard disk, and the like. The terminal input unit 23 is used for performing various operations (a game operation, and the like) by the player, and is realized, for example, by an operation button, a touch panel, and the like. The terminal display unit 24 is used for displaying a game screen by a command from the terminal control unit 21, and is realized, for example, by a liquid crystal display (LCD) and the like. The terminal communication unit 25 functions as a transmission/reception unit for performing transmission/reception of various types of information with the server device 10 through the network 2, and is realized, for example, by a network interface card (NIC), and the like.

### <<Data Structure>>

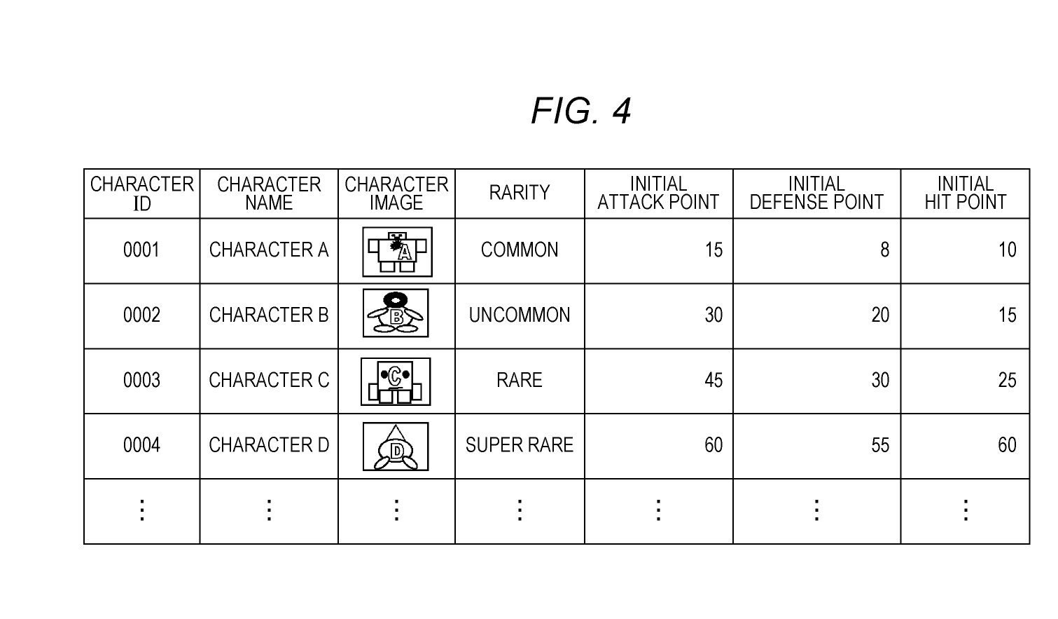

FIG. 4 is a diagram illustrating an example of a data structure of the character information stored in the storage unit 12 of the server device 10. The character information includes items (fields) such as a character ID, a character name, a character image, rarity, initial attack point, initial defense point, and initial hit point. The character ID is identification information that identifies a character. The character name is information that indicates a display name of a character. The character image is image data of a character. The rarity is information that indicates the degree of rarity classified into a plurality of classes according to a rarity value of a character. In the present embodiment, four classes of rarity (“common”→>“uncommon”→“rare”→>“super rare”) are set to characters. The initial attack point, the initial defense point, the initial hit point, and the like are parameters that indicate ability values initially set to a character.

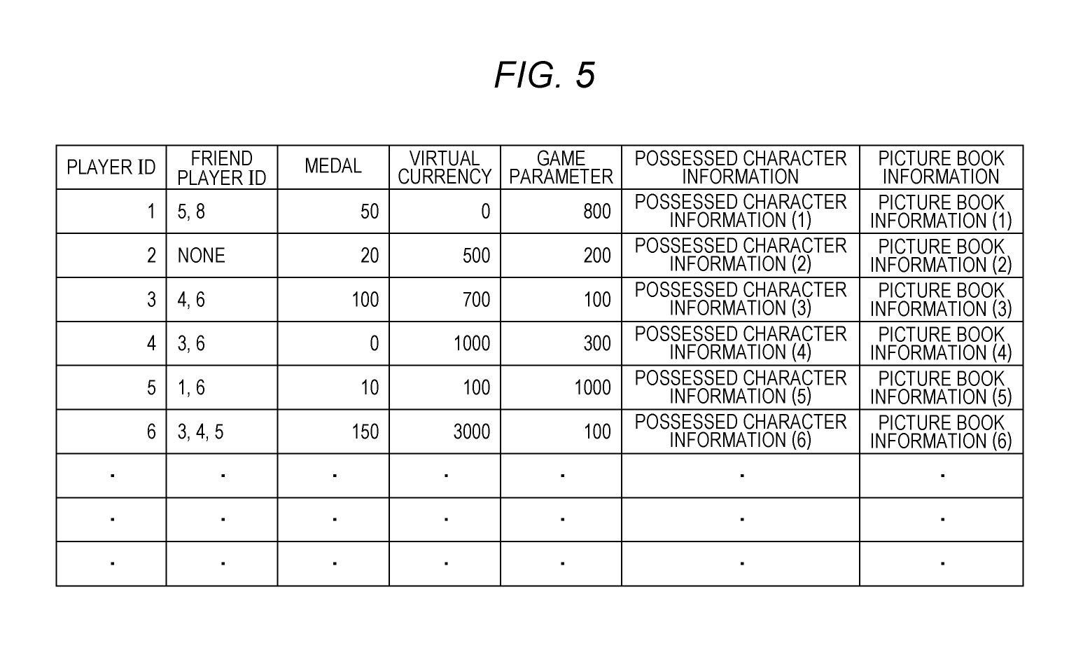

FIG. 5 is a diagram illustrating an example of a data structure of the player information stored in the storage unit 12 of the server device 10. The player information includes items such as a player ID, a friend player ID, a medal, virtual currency, a game parameter, possessed character information, and picture book information. The player ID is identification information that identifies the player. The friend player ID is identification information that identifies other players registered in a friend list of the player. That is, the larger the number of the friend player IDs registered, the more other players had become friends with the player. The medal is information that indicates a virtual medal as an example of a game value possessed by the player. The player can acquire the medal in a game in progress. The virtual currency is an example of the game value and is information indicating an amount of virtual currency possessed by the player. The player can purchase and possess the virtual currency. The game parameter is a parameter that indicates an accumulation state of points possessed by the player. In the present embodiment, the player can accumulate the number of points corresponding to a character. The possessed character information is information that indicates a character possessed by the player (hereinafter, also referred to as possessed character). The picture book information is history information that indicates a history of a possessed character that has been possessed by the player before.

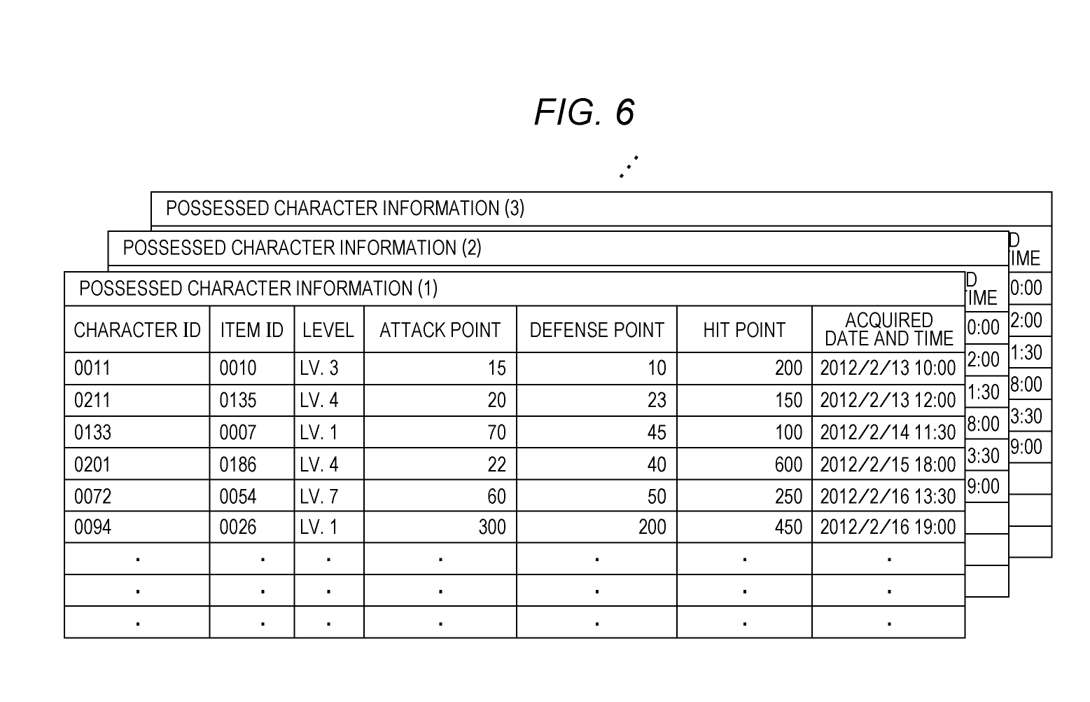

FIG. 6 is a diagram illustrating an example of a data structure of the possessed character information. The possessed character information includes items such as a character ID, an item ID, the level of a character, attack point, defense point, hitl point, and an acquired date and time. The character ID is identification information that identifies a possessed character. The level of a possessed character, the attack point, the defense point, and the hit point are parameters that indicate ability values set to a possessed character. These various parameters are updated according to a result of a battle game, and the like. The acquired date and time is information that indicates a date and time at which the player acquired a possessed character.

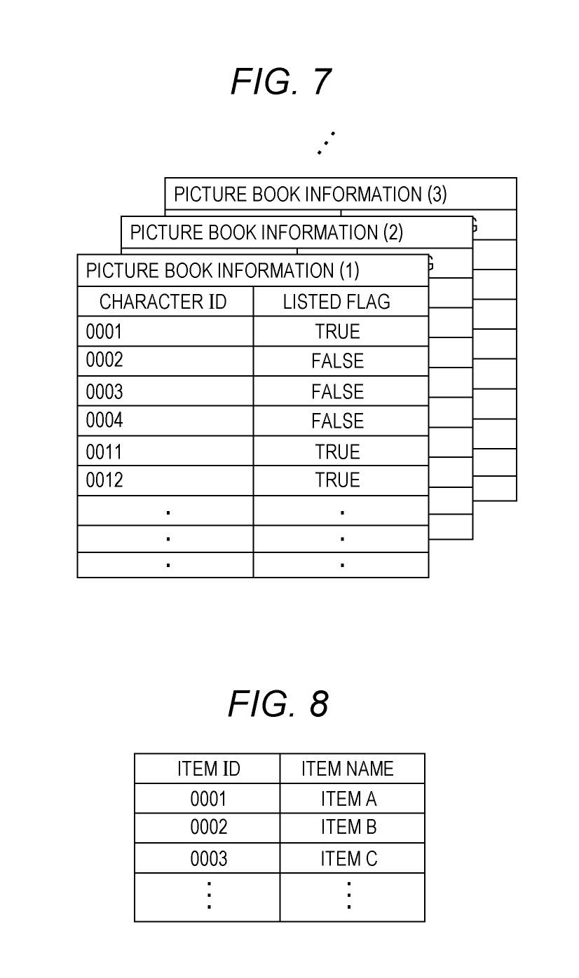

FIG. 7 is a diagram illustrating an example of a data structure of the picture book information. The picture book information includes items such as a character ID and flag information. The character ID is identification information that identifies a possessed character that has been possessed by the player before. In the flag information, “TRUE” is set to a character ID of a character that has been possessed before, and “FALSE” is set to a character ID of a character that has not been possessed before.

FIG. 8 is a diagram illustrating an example of a data structure of the item information. The item information includes items such as an item ID and an item name. The item ID is identification information identifying various items that the character is equipped with/possesses. The item name is information indicating a display name of the item.

### <<Outline of Game>>

Here, an outline of a game provided by the game system 1 of the present embodiment will be described. In the game system 1, a battle game performed using a game character is provided.

### <Battle Game>

In the game system 1 of the present embodiment, the player can possess a plurality of game characters. The player can play a battle game using a character selected from among the plurality of possessed game characters. The battle processing unit 115 determines an enemy character to battle against the character selected by the player, and determines an outcome of the battle game between the characters based on the various parameters (the attack point, the defense point, the hit point, and the like) set to the characters.

### <Providing of Character>

In the game system 1 of the present embodiment, a character is provided to the player when the player wins the battle game against the enemy character, or when a lottery game, so-called “Gacha Gacha” (registered trademark), is performed.

The lottery game is a game in which a character selected from among the plurality of characters is provided to the player. In this lottery game, a regular lottery game and a special lottery game are performed. The regular lottery game is a game in which one character is provided to the player in one lottery. The special lottery game is a game in which a plurality of characters is provided to the player in one lottery. The player can selectively play the regular lottery game and the special lottery game.

In this way, the player can increase the number of characters possessed by the player until the number reaches an upper limit by possessing the character provided through the lottery game and the like (hereinafter, also referred to as provided character). Then, the player can play the battle game described above using the character possessed by the player. In addition, the player can convert a certain possessed character into points, and can reinforce another character using the points.

### <Reinforcement of Main Character>

In the game system 1 of the present embodiment, the player can designate any possessed character as a main character (also, referred to as “base character”), and can also designate the possessed character as a sub character (also, referred to as “material character”).

In the game system 1 of the present embodiment, the player can convert the sub character into points, can accumulate the converted points in the game parameter, and can increase a parameter set to the main character to be reinforced using the accumulated points.

For example, when the number of possessed characters reaches the upper limit, the player designates an unnecessary material character from among the plurality of possessed characters. Then, the material character is converted into points, and the converted points are accumulated in the game parameter. The material character is set as a character not possessed by the player when converted into the points. With this, the number of possessed character can remain within the limit Following that, the player designates a necessary base character from the plurality of possessed characters as a character to be reinforced. Then, the player consumes the accumulated points (decreases the game parameter), and increases the ability parameter set to the base character according to the number of consumed points. The base character can be reinforced, accordingly.

As described above, the player can be caused to have a feeling as if he/she maintains possession of a character (the possession of which has been given up) by accumulating the points, and efficient use of the unnecessary character can be reinforced by using the points.

### <Point Conversion of Sub Character>

In the game system 1 of the present embodiment, there are two types of point conversion: a method of converting a character designated by the player into points (manual point conversion), and a method of converting an automatically selected character to points without a designation operation by the player (automatic point conversion).

In the manual point conversion, there are two types of manual conversion: a method of individually designating a material character to be converted (individual selection), and a method of automatically collectively designating characters having a predetermined relationship with the base character (collective selection).

In the automatic point conversion, a character provided through a lottery game is automatically converted into points.

The player can appropriately select any method according to the situation and the like.

### <<<Operation of Game System 1>>>

Here, an operation example of the game system 1 according to the present embodiment will be described. In the game system 1 of the present embodiment, an operation of setting a base character, an operation of accumulating points of a material character, and an operation of reinforcing the base character are performed. Hereinafter, each operation will be specifically described.

### <<Setting of Base Character>>

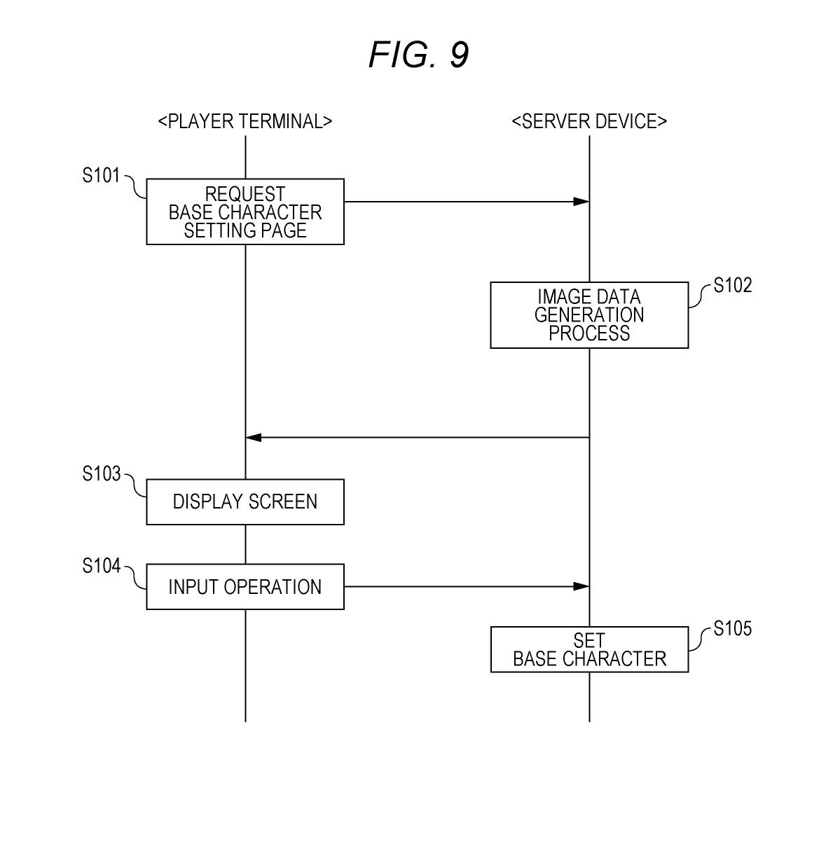

FIG. 9 is a flowchart for describing an example of an operation related to setting of a base character.

First, in the player terminal 20, the terminal control unit 21 transmits a command (base character setting page request) for acquiring a web page for setting a base character to the server device 10 through the terminal communication unit 25 upon receiving an operation input of the player from the terminal input unit 23 (S101).

Next, the server device 10 causes the screen data generation unit 117 to generate screen data (HTML file) for displaying a game screen (web page) for base character setting in the player terminal 20 upon receiving the base character setting page request transmitted from the player terminal 20 (S102). The server device 10 transmits the screen data (HTML file) of a game screen (web page) generated in this way to the player terminal 20 as a requestor through the network.

Next, the player terminal 20 displays the game screen (web page) corresponding to the screen data in the terminal display unit 24 by analyzing the screen data upon receiving the screen data (HTML data) transmitted from the server device 10 (S103).

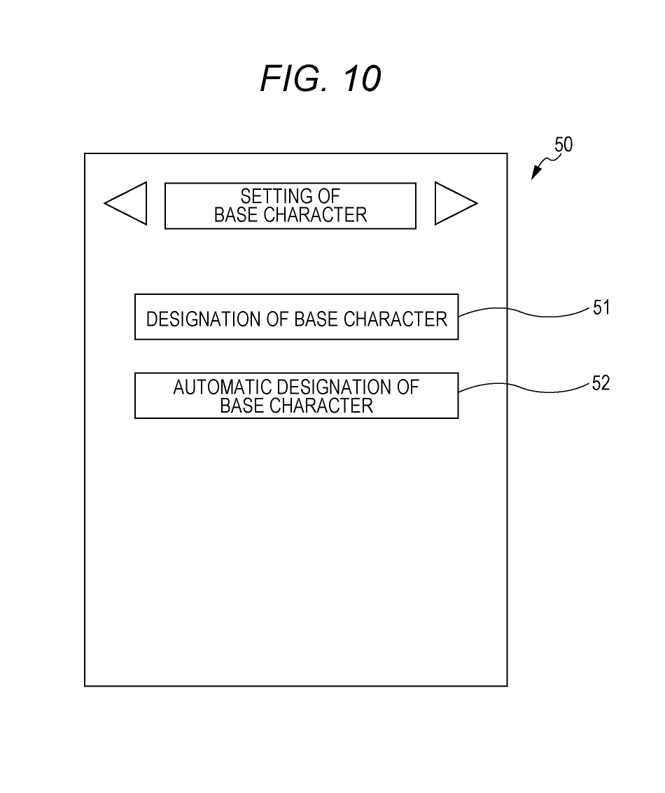

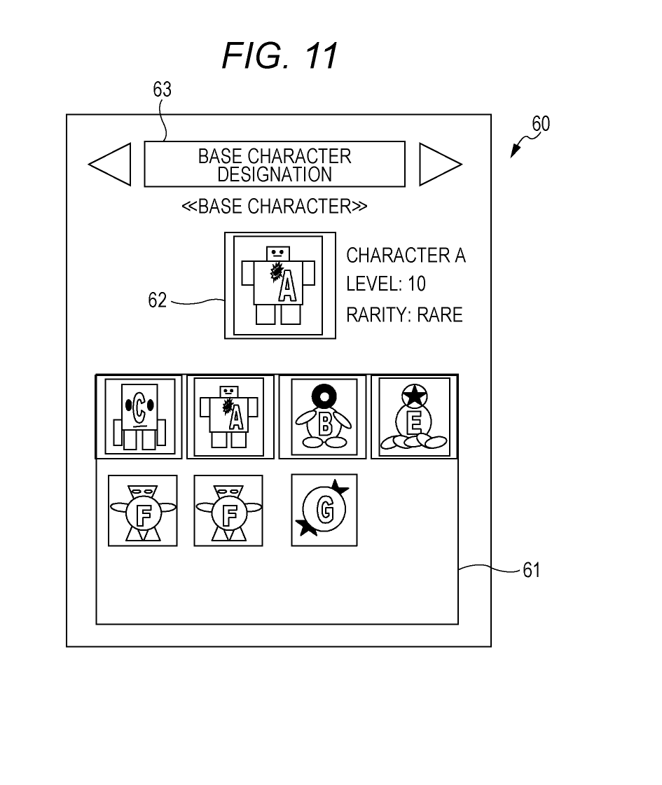

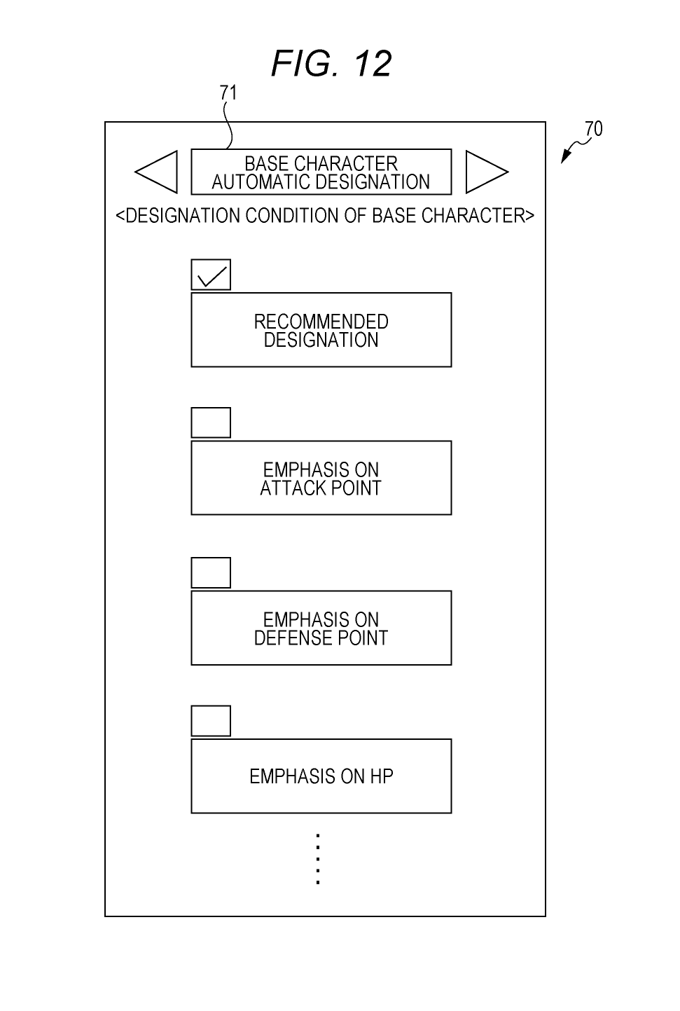

FIG. 10 is a diagram illustrating an example of a game screen 50 for base character setting displayed in the terminal display unit 24. The game screen 50 is a game screen for allowing the player to perform an operation input related to the setting of a base character, and includes a base character designation button 51 and a base character automatic designation button 52. When the base character designation button 51 is selected by the player, the game screen 50 makes a transition to a game screen 60 for allowing the player to designate a base character (see FIG. 11). Further, when the base character automatic designation button 52 is selected by the player, the game screen 50 makes a transition to a game screen 70 for automatically selecting a base character (see FIG. 12).

The game screen 60 illustrated in FIG. 11 includes a possessed character display area 61, a base character display area 62, and a base character setting button 63. When any from the plurality of possessed characters arranged on the possessed character display area 61 is designated by the player with an operation input, the designated character is arranged on the base character display area 62. Then, when the base character setting button 63 is selected by the player, the character arranged on the base character display area 62 is determined to be the base character.

Meanwhile, a base character automatic designation button 71 and a plurality of designation conditions when a base character is automatically designated are displayed on the game screen 70 illustrated in FIG. 12. When any of check boxes of the designation conditions is selected by the player with an operation input and the base character automatic designation button 71 is selected, a base character is automatically determined based on the selected designation condition.

Next, referring back to FIG. 9, when an operation input related to the designation of a base character is performed in this way, operation information related to the designation of a base character is transmitted from the player terminal 20 to the server device 10 (S104).

Next, the server device 10 performs setting registration of the base character based on the operation information received from the player terminal 20 (S105). To be specific, when the base character is designated through the game screen 60 illustrated in FIG. 11, the character selection unit 111 in the server device 10 refers to the possessed character information illustrated in FIG. 6, selects the base character according to the designation of the player, and performs setting registration in the storage unit 12. In addition, when the designation condition of the base character is selected by the player on the game screen 70 illustrated in 12, the character selection unit 111 refers to the possessed character information illustrated in FIG. 6, selects the base character according to the designation condition, and performs setting registration in the storage unit 12.

The base character set and registered in this way is reinforced by consumption of the points converted from the material character. Hereinafter, the accumulation of the points will be described.

### <<Accumulation of Points>>

Next, an example of an operation of accumulating points of a material character will be described. In the present embodiment, there are two cases of accumulation of points: a case of accumulating points by performing manual point conversion, and a case of accumulating points by performing automatic point conversion. Hereinafter, each of the cases will be specifically described. Note that, in the present embodiment, description will be given using the material character as a character, points of which are to be accumulated. However, any character can be the character, points of which are to be accumulated.

### <Manual Point Conversion>

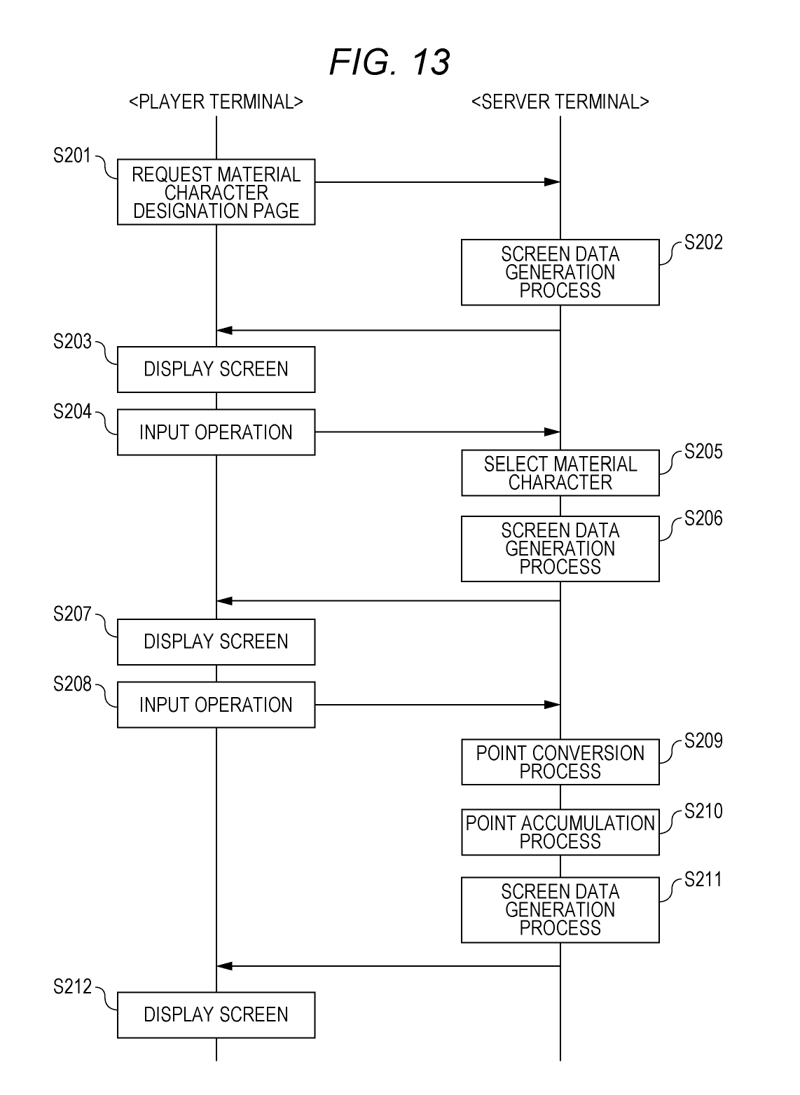

FIG. 13 is a flowchart for describing an example of an operation of accumulating points by performing manual point conversion.

First, in the player terminal 20, the terminal control unit 21 transmits a command (material character designation page request) for acquiring a web page for designating a material character to the server device 10 through the terminal communication unit 25 upon receiving an operation input of the player from the terminal input unit 23 (S201).

Next, the server device 10 causes the screen data generation unit 117 to generate screen data (HTML file) for displaying a game screen (web page) for material character designation in the player terminal 20 upon receiving the material character designation page request transmitted from the player terminal 20 (S202). The server device 10 transmits the screen data (HTML file) of a game screen (web page) generated in this way to the player terminal 20 as a requestor through the network.

Next, the player terminal 20 displays the game screen (web page) corresponding to the screen data in the terminal display unit 24 by analyzing the screen data upon receiving the screen data (HTML data) transmitted from the server device 10 (S203).

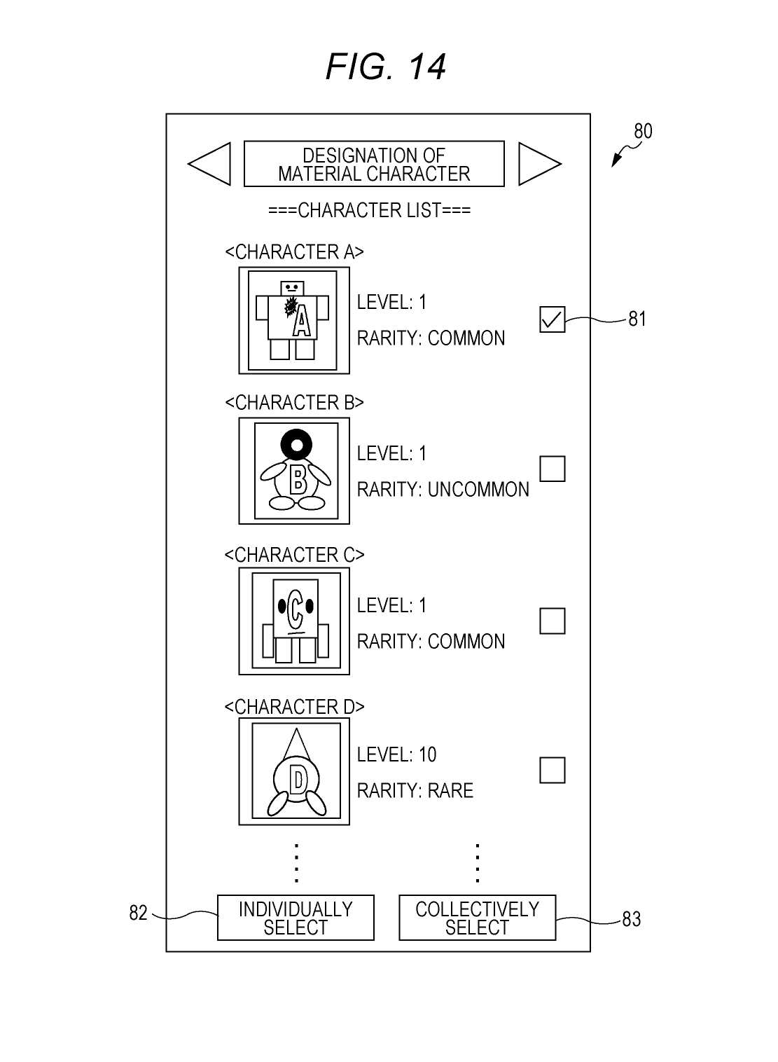

FIG. 14 is a diagram illustrating an example of a game screen 80 for material character setting displayed in the terminal display unit 24. The game screen 80 is a game screen for allowing the player to perform an operation input related to designation of a material character, and includes a check box 81, an individual selection button 82, and a collective selection button 83.

When individually selecting a material character, the player designates an unnecessary character from the possessed characters displayed in a list by selection of the check box 81, and then selects the individual selection button 82. Meanwhile, when collectively designating material characters, the player selects the collective selection button 83.

Next, referring back to FIG. 13, when an operation input related to the designation of a material character is performed by the player in this way, operation information related to the designation of a material character is transmitted from the player terminal 20 to the server device 10 (S204).

Next, the server device 10 selects a material character based on the operation information received from the player terminal 20 (S205). To be specific, when the individual selection button 82 is selected on the game screen 80 illustrated in FIG. 14, the character selection unit 111 in the server device 10 refers to the possessed character information illustrated in FIG. 6, selects the material character according to the designation of the player, and registers the material character in the storage unit 12. In addition, when the collective selection button 83 is selected on the game screen 80 illustrated in FIG. 14, the character selection unit 111 refers to the possessed character information illustrated in FIG. 6, collectively selects characters, to which a parameter that satisfies a predetermined condition is set, as the material characters, and registers the material characters in the storage unit 12. For example, the character selection unit 111 refers to the possessed character information illustrated in FIG. 6, and collectively selects only the possessed characters having a “level 1”.

Next, after the selection of the material characters, the server device 10 causes the screen data generation unit 117 to generate screen data (HTML file) for displaying a game screen (web page) in the player terminal 20 (S206). The server device 10 transmits the screen data (HTML file) of a game screen (web page) generated in this way to the player terminal 20 as a requestor through the network.

Next, the player terminal 20 displays the game screen (web page) corresponding to the screen data in the terminal display unit 24 by analyzing the screen data upon receiving the screen data (HTML data) transmitted from the server device 10 (S207).

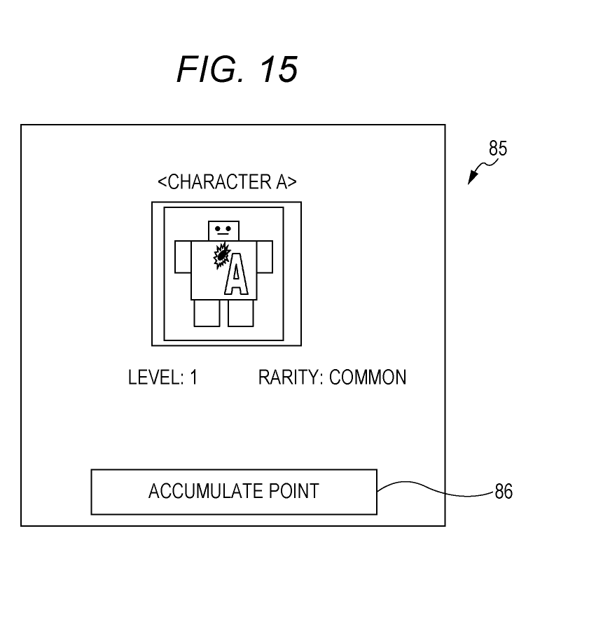

FIG. 15 is a diagram illustrating an example of a game screen 85 for individual selection displayed in the terminal display unit 24. The game screen 85 is a game screen that explicitly indicates the material character set as a result of the individual selection, and allows the player to perform an operation input related to the accumulation of points with an operation button 86.

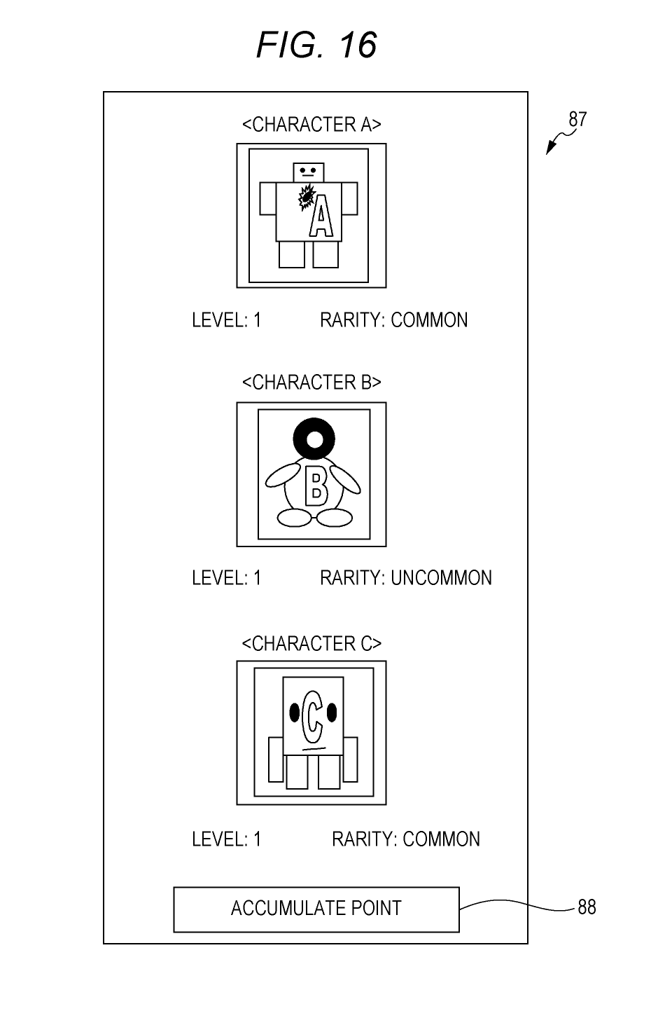

FIG. 16 is a diagram illustrating an example of a game screen 87 for collective selection displayed in the terminal display unit 24. The game screen 87 is a game screen that explicitly indicates the material characters set as a result of the collective selection, and allows the player to perform an operation input related to the accumulation of points with an operation button 88.

In the game screen illustrated in FIG. 15 or 16, when the player selects the operation button 86 or the operation button 88, points corresponding to the material character displayed in FIG. 15 or 16 can be accumulated in the game parameter.

Next, referring back to FIG. 13, when an operation input related to the accumulation of points is performed by the player by the selection of the operation button 86 or the operation button 88, operation information related to the accumulation of points is transmitted from the player terminal 20 to the server device 10 (S208).

Next, the server device 10 performs a point conversion process based on the operation information received from the player terminal 20 (S209). To be specific, the point accumulation unit 112 in the server device 10 determines the number of points corresponding to the material character selected by the character selection unit 111 in the individual selection or the collective selection. Here, the number of determined points can be a uniform number of points (for example, 1.2 points) regardless of characters.

The point accumulation unit 112 in the present embodiment converts a larger number of points when the material character (a character that is to be converted into points) has a predetermined relationship with the base character (a character to be reinforced by the converted points) than when the character has no predetermined relationship with the base character. For example, the point accumulation unit 112 converts the character into 1.5 times the uniform number of points (for example, 1.8 points instead of the uniform 1.2 points) when the material character is the same as (or related to) the base character, or when the material character has the same rarity as the base character.

Further, the point accumulation unit 112 in the present embodiment converts a material character into a large number of points when the material character is a special character than when the material character is not a special. For example, the point accumulation unit 112 concerts a material character into five times the uniform points when the character is only available in a particular event (the character has a low appearance probability), compared with a case where the character can be easily obtained (the character has a high appearance probability) (for example, 6 points instead of the uniform 1.2 points).

Following that, the server device 10 performs a process of point accumulation (S210). To be specific, the point accumulation unit 112 in the server device 10 updates the possessed character information (see FIG. 6) so that the material character selected by the character selection unit 111 in the individual selection or the collective selection is made into a character no possessed by the player. In addition to that, the point accumulation unit 112 updates the possessed character information (see FIG. 6) by adding the number of points corresponding to the material character to the game parameter.

Next, after the accumulation of the points, the server device 10 causes the screen data generation unit 117 to generate screen data (HTML file) for displaying a game screen (web page) in the player terminal 20 (S211). The server device 10 transmits the screen data (HTML file) of a game screen (web page) generated in this way to the player terminal 20 as a requestor through the network.

Next, the player terminal 20 displays the game screen (web page) corresponding to the screen data in the terminal display unit 24 by analyzing the screen data upon receiving the screen data (HTML data) transmitted from the server device 10 (S212).

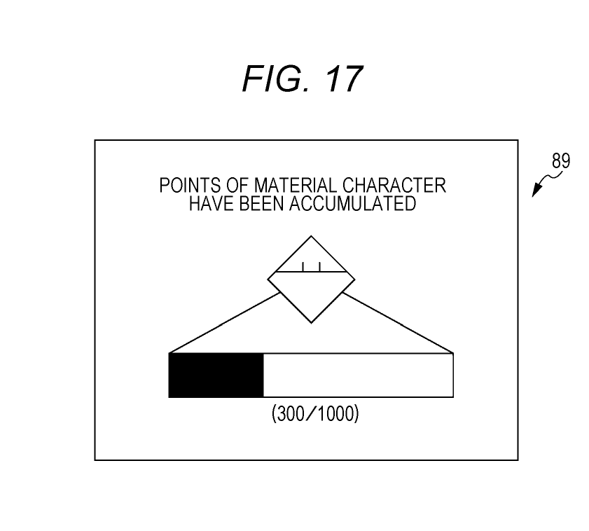

FIG. 17 is a diagram illustrating an example of a game screen 89 for point accumulation displayed in the terminal display unit 24. On the game screen 89, the fact that the points of the material character have been accumulated in the game parameter is indicated by a bar graph gauge.

### <Automatic Point Conversion>

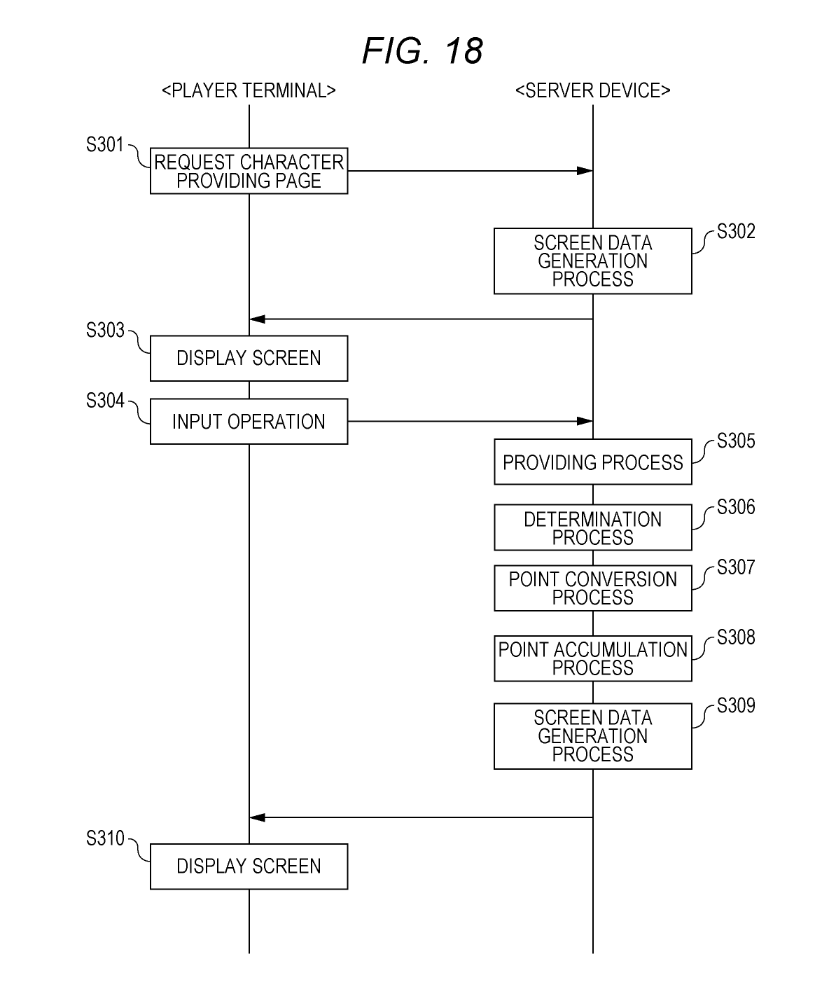

FIG. 18 is a flowchart for describing an example of an operation of accumulating points by performing automatic point conversion.

First, in player terminal 20, the terminal control unit 21 transmits, to the server device 10 through the terminal communication unit 25, a command (character providing request) for acquiring a web page for starting character providing upon receiving an operation input of the player from the terminal input unit 23 (S301).

Following that, the server device 10 causes the screen data generation unit 117 to generate screen data (HTML file) for displaying a game screen (web page) for character providing in the player terminal 20 upon receiving the character providing request transmitted from the player terminal 20 (S302). The server device 10 transmits the screen data (HTML file) of a game screen (web page) generated in this way to the player terminal 20 as a requestor through the network.

Following that, the player terminal 20 displays the game screen (web page) corresponding to the screen data in the terminal display unit 24 by analyzing the screen data upon receiving the screen data (HTML data) transmitted from the server device 10 (S303).

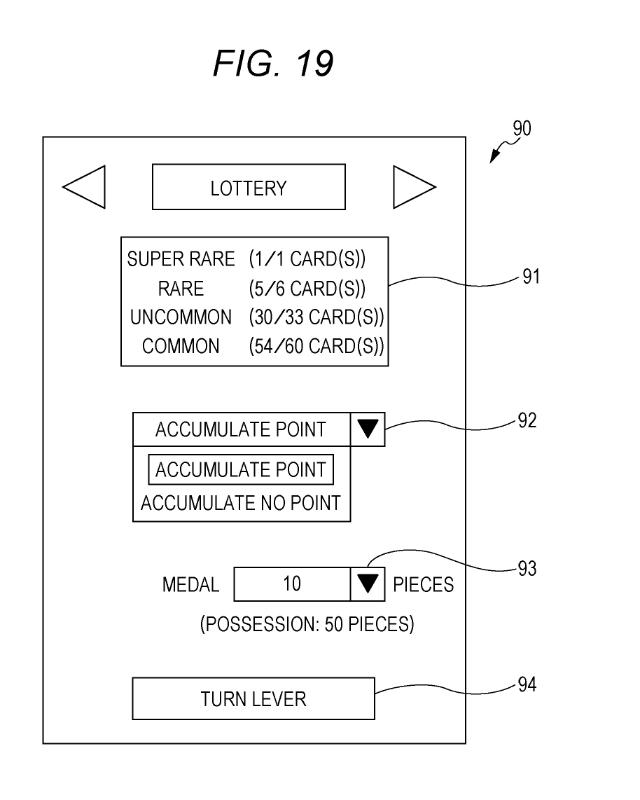

FIG. 19 is a diagram illustrating an example of a game screen 90 for character providing displayed in the terminal display unit 24. The game screen 90 is a game screen for allowing the player to perform a lottery game, and includes a character number information 91 that is information expressing the number of characters acquirable by a lottery game for each rarity, a pull-down menu 92 for setting enabling/disabling of automatic point conversion, a pull-down menu 93 for setting a regular lottery game/special lottery game, and an operation button 94 for starting a lottery game.

The player terminal 20 receives an operation input related to a lottery game from the player during the game screen 90 for character providing being displayed in the terminal display unit 24 (S304). The player designates enabling/disabling of the automatic point conversion by operating the pull-down menu 92. When “accumulate a point” is selected by an operation of the player, the automatic point conversion being enabled is designated. Further, the player designates the number of medals to be consumed in the lottery game by operating the pull-down menu 93 using the character number information 91 as a reference. Here, one medal is selected by an operation of the player, a regular lottery game is performed, and two or more medals are selected, a special lottery game is performed. After the designation, when the operation button 94 is selected by the player, the player terminal 20 transmits a lottery game execution request, in which the operation information is set, to the server device 10.

Next, referring back to FIG. 18, the server device 10 executes a process of providing the player with a character through a lottery game upon receiving the lottery game execution request transmitted from the player terminal 20 (S305). To be specific, the providing unit 116 executes a game process related to the lottery game, and provides the player with a character selected with a random number from a plurality of characters by referring to the character information illustrated in FIG. 4. The providing unit 116 provides one character in one lottery in the regular lottery game, and provides a plurality of characters in one lottery in the special lottery game.

Next, the server device 10 performs a determination process of performing determination related to the automatic point conversion (S306). To be specific, the determination unit 114 determines whether the character provided by the providing unit 116 satisfies a predetermined condition.

For example, the determination unit 114 determines whether the character provided by the providing unit 116 is a new character that has not been possessed by the player before by referring to the picture book information illustrated in FIG. 7. When the determination is denied, the character selection unit 111 selects the character provided by the providing unit 116 as a material character that serves as a character to be subjected to the automatic point conversion.

Further, for example, the determination unit 114 determines whether the rarity of the character provided by the providing unit 116 is common by referring to the character information illustrated in FIG. 4. When the determination is affirmed, the character selection unit 111 selects the character provided by the providing unit 116 as a material character that serves as a character to be subjected to the automatic point conversion.

The material character that becomes a character to be subjected to the automatic point conversion in this way is automatically converted into points, and the points are accumulated in the game parameter.

Note that, since processes from step S307 to step S310 in FIG. 18 are similar to the processes from step S209 to step S212 in FIG. 13, description is omitted.

### <<Reinforcement of Base Character>>

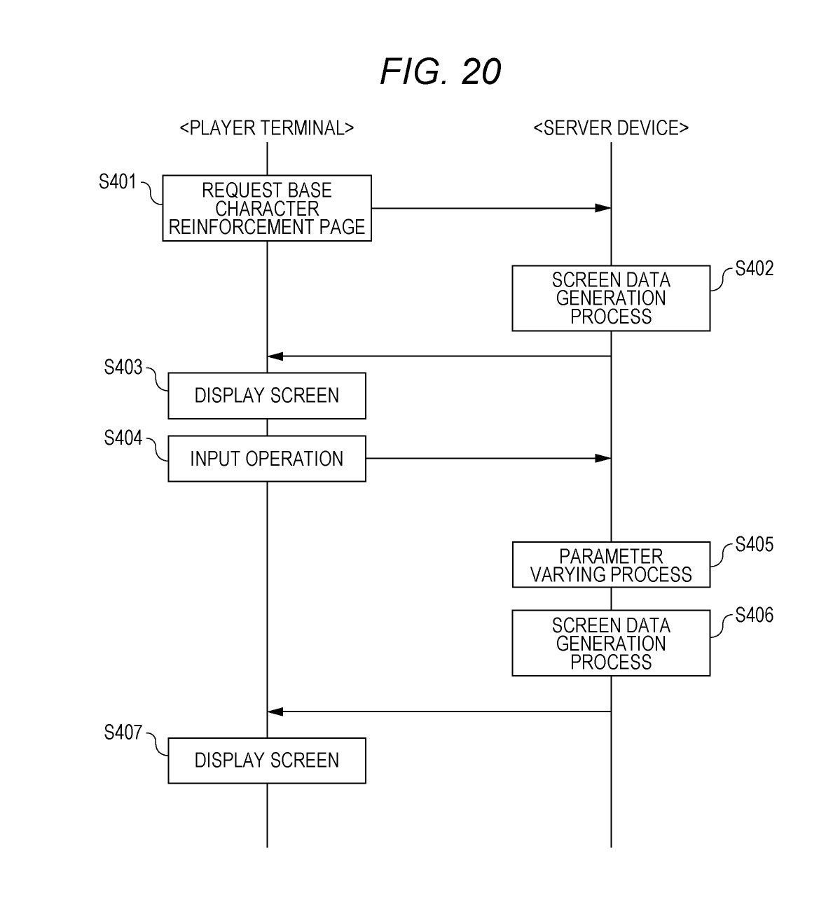

FIG. 20 is a flowchart for describing an example of an operation related to reinforcement of a base character.

First, in the player terminal 20, the terminal control unit 21 transmits a command (base character reinforcement page request) for acquiring a web page for reinforcing a base character to the server device 10 through the terminal communication unit 25, upon receiving the operation input (operation input for reinforcing an arbitrarily selected base character) of the player from the terminal input unit 23 (S401).

Next, the server device 10 causes the screen data generation unit 117 to generate screen data (HTML file) for displaying a game screen (web page) for base character reinforcement in the player terminal 20 upon receiving the base character reinforcement page request transmitted from the player terminal 20 (S402). The server device 10 transmits the screen data (HTML file) of a game screen (web page) generated in this way to the player terminal 20 as a requestor through the network.

Following that, the player terminal 20 displays the game screen (web page) corresponding to the screen data in the terminal display unit 24 by analyzing the screen data upon receiving the screen data (HTML data) transmitted form the server device 10 (S403).

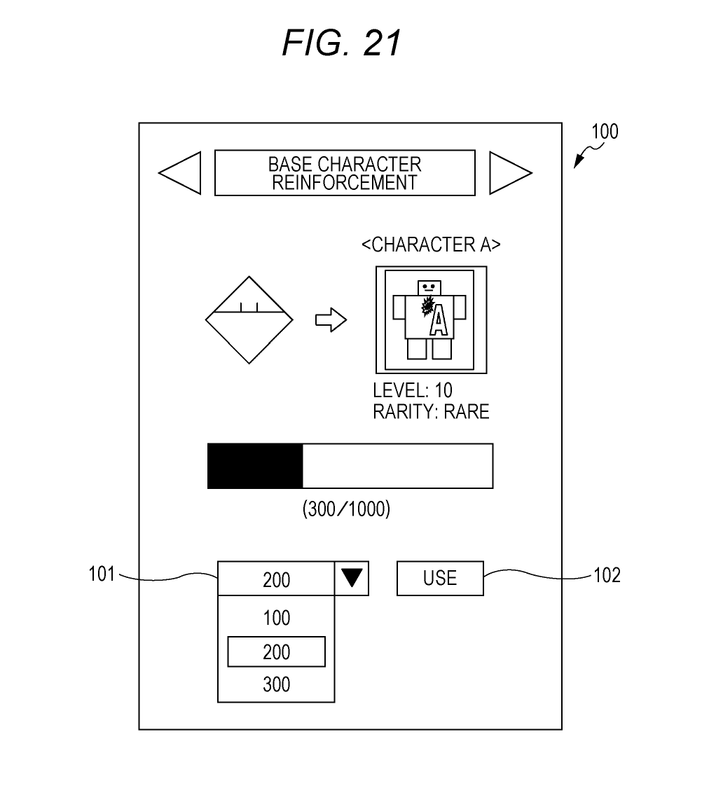

FIG. 21 is a diagram illustrating an example of a game screen 100 for base character reinforcement displayed in the terminal display unit 24. The game screen 100 includes a pull-down menu 101 for designating the number of points to be consumed and an operation button 102 for starting reinforcement of a base character.

The player terminal 20 receives an operation input related to the base character reinforcement from the player during the game screen 100 for base character reinforcement being displayed on the terminal display unit 24 (S404). The player designates the number of points to be consumed for reinforcing the base character by operating the pull-down menu 101 while looking at the bar graph gauge displayed on the game screen 100. After the designation, when the operation button 102 is selected by the player, the player terminal 20 transmits a base character reinforcement execution request in which the operation information is set to the server device 10.

Next, referring back to FIG. 20, the server device 10 executes a parameter varying process upon receiving the base character reinforcement execution request transmitted from the player terminal 20 (S405). To be specific, the parameter varying unit 113 decreases the number of points of the game parameter according to the designation of the player to update the player information illustrated in FIG. 5. In addition, the parameter varying unit 113 reinforces the base character by increasing the ability parameter (level or the like) set to the base character and updates the possessed character information illustrated in FIG. 6.

Following that, after the base character reinforcement, the server device 10 causes the screen data generation unit 117 to generate screen data (HTML file) for displaying a game screen (web page) in the player terminal 20 (S406). The server device 10 transmits the screen data (HTML file) of a game screen (web page) generated in this way to the player terminal 20 as a requestor through the network.

Next, the player terminal 20 displays the game screen (web page) corresponding to the screen data in the terminal display unit 24 by analyzing the screen data, upon receiving the screen data (HTML data) transmitted from the server device 10 (S407).

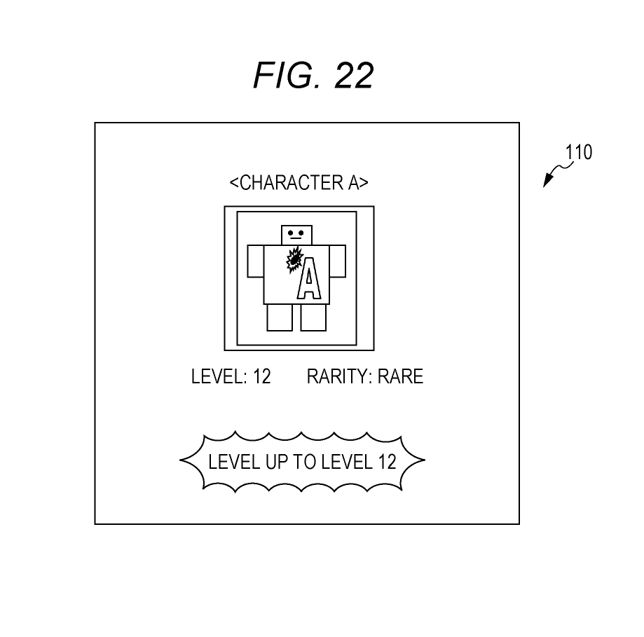

FIG. 22 is a diagram illustrating an example of a game screen 110 illustrating the base character after reinforcement displayed in the terminal display unit 24. When the number of points “200” is consumed on the game screen 100 illustrated in FIG. 21, the ability parameter of “character A” is increased from the “level 10” to the “level 12” on the game screen 110 illustrated in FIG. 22. Therefore, it can be seen that the base character has been reinforced by consumption of the points.

As described above, according to the game system 1 of the present embodiment, the material character is converted into points, the converted points are accumulated in the game parameter, and the accumulated points are consumed, so that the parameter set to the base character to be reinforced is increased. Therefore, when the player selects an unnecessary character from the plurality of possessed characters as a material character and applies the point conversion to the selected character, the player can keep the material character as the points even if there is a limit to the number of possessed characters. Therefore, the player can be caused to have a feeling as if he/she maintains possession of the character. Furthermore, the player can reinforce the base character by consuming the accumulated points, whereby efficient use of unnecessary characters can be reinforced.

### Other Embodiments

The above-described embodiments have been given for easy understanding of the present invention, and are not used to construe the present invention in a limited manner. The present invention can be changed and improved without departing from the gist of the invention and includes its equivalents. Especially, embodiments described below are also included in the present invention.

### <Automatic Point Conversion>

In the above-described embodiment, a case has been described, in which the determination unit 114 determines whether the character provided by the providing unit 116 satisfies a predetermined condition, and when the determination is affirmed, the point accumulation unit 112 automatically converts the character provided by the providing unit 116 into points and accumulates the points (step S306 of FIG. 18). However, the predetermined condition may be the condition below.

For example, a plurality of types of lottery games is prepared in advance. As the types of lottery games, assume that there are at least two types of lottery games: a first lottery game that is performed by consuming medals, and a second lottery game that is performed by consuming virtual currency. Under this circumstance, the fact that the player plays the first lottery game may be the predetermined condition. That is, the determination unit 114 determines whether the first lottery game among the plurality of types of lottery games is performed, and when the determination is affirmed, the point accumulation unit 112 may automatically convert the character provided by the providing unit 116 in the first lottery game into points and accumulate the points.

Alternatively, for example, the fact that the character provided by the providing unit 116 does not have a special item may be the predetermined condition. That is, the determination unit 114 determines whether a special item is corresponding to the character provided by the providing unit 116 and is stored, and when the determination is denied, the point accumulation unit 112 may automatically convert the character provided by the providing unit 116 into points and accumulate the points.

### <Server Device 10>

In the above-described present embodiments, the game system 1 provided with one server device 10 as an example of a server device has been exemplarily described. However, the game system 1 is not limited to this example, and may be provided with a plurality of server devices 10 as an example of the server device. That is, a plurality of server devices 10 is connected through a network 2, and each of the server devices 10 may perform various types of processing in a distributed manner.

<Information processing device>

In the above-described game system 1 in the present embodiments, a case has been exemplarily described, in which various types of processing are executed based on a game program by the server device 10 and the player terminal 20 in cooperation with each other. However, the game system 1 is not limited to the example. The above-described various types of processing may be executed by the player terminal 20 alone or by the server device 10 alone as an information processing device based on the game program.

Further, it may be configured such that the player terminal 20 bares a part of the functions as the information processing device. In this case, the server device 10 and the player terminal 20 constitute the information processing device.

Note that the information processing device is an example of a computer provided with a processor and a memory.

What is claimed is:

1. An information processing device comprising:
a storage unit configured to store possessed character information that is information related to characters possessed by a player and a game parameter indicating an accumulation state of points possessed by the player in association with the player;
a character selection unit configured to select a main character and a sub character from among the characters possessed by the player;
a point accumulation unit configured to accumulate points by updating the possessed character information so that the sub character selected by the character selection unit is made into a character not possessed by the player and by adding the number of points corresponding to the sub character to the game parameter; and
a parameter varying unit configured to vary a parameter set to the main character by causing the points accumulated by the point accumulation unit to be consumed.

2. The information processing device according to claim 1, comprising:
a providing unit configured to provide the player with a character; and
a determination unit configured to determine whether the character provided by the providing unit satisfies a predetermined condition,
wherein the character selection unit automatically selects the character provided by the providing unit as the sub character when the determination is denied by the determination unit, and
the point accumulation unit automatically adds the number of points corresponding to the sub character to the game parameter.

3. The information processing device according to claim 1, comprising:
a providing unit configured to provide the player with a character selected by performing any of a plurality of types of lottery games; and
a determination unit configured to determine whether a lottery game that satisfies a predetermined condition among the plurality of types of lottery games has been performed,
wherein the character selection unit automatically selects the character provided by the lottery game that satisfies the predetermined condition as the sub character when the determination is affirmed by the determination unit, and
the point accumulation unit automatically adds the number of points corresponding to the sub character to the game parameter.

4. The information processing device according to claim 1,
wherein the character selection unit collectively selects the sub characters to which a parameter that satisfies a predetermined condition is set from among the characters possessed by the player in response to an operation input from the player.

5. The information processing device according to claim 1,
wherein the point accumulation unit adds a larger number of points to the game parameter when the sub character selected by the character selection unit has a predetermined relationship with the main character than when the sub character does not have the predetermined relationship with the main character.

6. A non-transitory computer-readable storage medium storing a game program for causing a computer to execute the processing of:
storing, in a storage unit, possessed character information that is information related to characters possessed by a player and a game parameter indicating an accumulation state of points possessed by the player in association with the player;
selecting a main character and a sub character from among the characters possessed by the player;
accumulating points by updating the possessed character information so that the sub character selected by the character selection unit is made into a character not possessed by the player and by adding the number of points corresponding to the sub character to the game parameter; and
varying a parameter set to the main character by causing the points accumulated by the point accumulation unit to be consumed.
